(19) United States
(12) Patent Application Publication
(10) Pub. No.: US 2012/0061431 A1
(43) Pub. Date: Mar. 15, 2012

(54) Sheet dispensing device and utility belt

(76) Inventor: Lauren Raines, Coatesville, PA (US)

(21) Appl. No.: 13/199,322

(22) Filed: Aug. 26, 2011

Related U.S. Application Data
(60) Provisional application No. 61/402,243, filed on Aug. 26, 2010.

(51) Int. Cl. A45F 5/02; B23P 11/00

(52) U.S. Cl. 224/240; 224/195; 29/428

(57) ABSTRACT

The present invention provides a device for holding articles. In one embodiment, the invention may comprise a pouch for holding articles wherein the pouch may be attached to a belt, strap, or other device which may be worn. The pouch and/or belt may also be aesthetically pleasing and fashionable for use by a child or adult. The present invention further provides for a sheet dispensing device which comprises a front surface, which has a dispensing opening therein, and a rear surface. The front surface and rear surface form a compartment to store one or more sheets and may form an opening into the compartment where the sheets to be dispensed may be inserted and removed. The dispensing device may also comprise a flap which may cover the opening to the compartment and/or the sheet dispensing opening. The invention also provides for a method for assembling a sheet dispensing device.

### CROSS-REFERENCE TO RELATED APPLICATIONS

This application claims the priority of U.S. Provisional Patent Application Ser. No. 61/402,243, filed Aug. 26, 2010, entitled “Sheet Dispensing Device And Utility Belt,” the entirety of which is incorporated herein by reference.

### FIELD OF INVENTION

This invention is directed to an apparatus and method for holding, dispensing and/or accessing belongings. More specifically, the invention is directed to an apparatus and method for dispensing individual sheets such as tissues, wipes, and the like stored in a pouch or similar device which, optionally, may be attached to a belt or other device.

### BACKGROUND OF THE INVENTION

With the outbreak of the swine flu and many other life threatening viruses, people today are more concerned about spreading germs even as harmless as a common cold. In order to prevent viruses from spreading we are teaching adults and children alike to wash their hands, use bacteria killing hand wash and keep tissues handy. However, keeping tissues readily at hand can be a challenge particularly for parents, teachers and other care givers to children, the disabled, the elderly or other persons requiring assistance.

To meet the needs of busy parents, day care instructors, nursing care workers, people with visual impairments, adults on the go, and other persons, the instant invention, which may take the form of a utility belt for such persons, was developed to fashionably hold a travel size pack of tissues or wipes for easy access by an adult or child described herein. The invention which, in one embodiment, is adaptable for use for any person, is particularly suited to children. Without limitation as to the user of the instant invention, the invention disclosed herein is referred to herein as a “Baby Utility Belt” or “B.U.B.” The B.U.B. is designed to be worn by the person/child who needs the product in the pouch, encouraging self sufficiency and decreasing care-giver dependency.

### SUMMARY OF THE INVENTION

The present invention provides a pouch for holding articles. In one embodiment, the invention may comprise a pouch for holding articles wherein the pouch is attached to a belt, strap or other device which may be worn by the user of the pouch. For example, the pouch may be suitable for holding travel sized articles such as tissues, wet or dry towelettes, wipes, or other sheet-like or similar items which may be dispensed from the pouch. The pouch and/or belt may also be made to be aesthetically pleasing and fashionable so the pouch may be worn by a child or adult.

The invention may provide easy user, person, child, or care giver (individually or collectively referred to herein as “user”) access to belongings placed in the pouch. In one embodiment of the invention, the pouch may comprise a slit along a front panel. The slit may be used to individually dispense therethrough tissues, wipes, toewlettes, or similar articles stored in the pouch without removing all such articles from the pouch.

The invention may also optionally comprise a flap or other component which is intended to cover one or more of the openings in the pouch. For example, the flap may cover the opening through which the full contents of the pouch are inserted or removed, and/or the slit though which individual sheets of the contents may be dispensed. The front flap may also comprise closures which may consist of hidden snaps at select corners. Such closures may comprise snaps, Velcro,® magnets, belts and buckles, zippers, and/or other suitable closure devices.

On function of the flap may be to prevent or deter a user, and particularly a child, from gaining access to the contents of the pouch through either the opening through which the full contents of the pouch are inserted or removed, and/or the slit though which individual sheets of the contents may be dispensed.

The pouch may be further attached to a belt by a Velcro® enclosed flap or other suitable mounting device. This feature may allow for easy access and removal of the pouch from the belt apparatus for cleaning and safety concerns.

Although the B.U.B. may be worn in any manner convenient to the user, fashionable materials may be employed to allow for the B.U.B. to be worn outside of user's garment. Chosen fabrics also may be soft to further insure safety. Chosen fabrics may also be washable to address sanitary considerations.

The B.U.B. itself may also be adapted to be used on a single belt with two or more pouches which have the same or differing functionality. For example, one pouch may comprise the tissue dispensing pouch described above, while another pouch may comprise a pocket for holding items such as pacifiers, keys, coins, or other items, while another pouch may be configured or adapted to any other need or use the user may desire.

Thus, the present invention provides for a sheet dispensing device which comprises a front surface, which has a dispensing opening therein, and a rear surface. The front surface and rear surface form a compartment into which one or more sheets may be placed, and also may form an opening into the compartment into which the sheets may be inserted and removed. The sheets then may be dispensed, preferably individually, through the dispensing opening. Optionally, the dispensing device may also comprise a flap which may cover the opening to the compartment and/or the sheet dispensing opening.

The present invention also provides for a method for assembling a sheet dispensing device. The method may comprise the steps of (i) constructing a storage compartment which is suitable for housing one or more sheets to be dispensed; (ii) forming a first opening in the storage compartment through which the sheets may be dispensed; and (iii) forming a flap which may be positioned to cover opening through which the sheets may be dispensed.

### BRIEF DESCRIPTION OF THE DRAWINGS

FIG. 1 is a front elevation view of an embodiment of the Sheet Dispensing Device or pouch and Utility Belt of the instant invention which is capable of dispensing articles such as tissues, baby wipes and other sheet like articles, with the sheet dispensing device shown in the closed position;

FIG. 2 is a rear elevation view of the design of FIG. 1 shown with the sheet dispensing device attached to the utility belt, and the belt attachment flap in a closed position;

FIG. 3 is a rear elevation view of the design of FIG. 1 shown with the sheet dispensing device released from the utility belt, and the belt attachment flap in an opened position;

FIG. 4 is a front elevation view of an embodiment of the design of FIG. 1 with the sheet dispensing device shown in the open position to expose an elongated opening through which sheets may be dispensed;

FIG. 5 is a side elevation view of the design of FIG. 1 as viewed from the side adjacent to the right of the side shown in FIG. 1;

FIG. 6 is a side elevation view of the design of FIG. 1 as viewed from the side opposing the side shown in FIG. 5;

FIG. 7 is a bottom plan view of the design of FIG. 1 shown with the sheet dispensing device in a closed position, without the utility belt attached, and with the belt attachment flap in an opened position;

FIG. 8 is a perspective view of the design of FIG. 1 with the sheet dispensing device shown in the open position;

FIG. 9 is a front elevation view of another embodiment of the Sheet Dispensing Device or pouch and Utility Belt of the instant invention which is capable of dispensing articles such as tissues, baby wipes and other sheet like articles, with the sheet dispensing device shown in the closed position;

FIG. 10 is a rear elevation view of the design of FIG. 9 shown with the sheet dispensing device attached to the utility belt, and the belt attachment flap in a closed position;

FIG. 11 is a rear elevation view of the design of FIG. 9 shown with the sheet dispensing device released from the utility belt, and the belt attachment flap in an opened position;

FIG. 12 is a front elevation view of an embodiment of the design of FIG. 9 with the sheet dispensing device shown in the open position to expose an elongated opening through which sheets may be dispensed;

FIG. 13 is a side elevation view of the design of FIG. 9 as viewed from the side adjacent to the right of the side shown in FIG. 9;

FIG. 14 is a side elevation view of the design of FIG. 9 as viewed from the side opposing the side shown in FIG. 13;

FIG. 15 is a bottom plan view of the design of FIG. 9 shown with the sheet dispensing device in a closed position, without the utility belt attached, and with the belt attachment flap in an opened position;

FIG. 16 is a perspective view of the design of FIG. 9 with the sheet dispensing device shown in the open position;

FIG. 17 is a front elevation view of another embodiment of the Sheet Dispensing Device or pouch of the instant invention shown without the Utility Belt which is capable of dispensing articles such as tissues, baby wipes and other sheet like articles, with the sheet dispensing device shown in the closed position;

FIG. 18 is a rear elevation view of the design of FIG. 17 shown with the sheet dispensing device attached to the utility belt, and the belt attachment flap in a closed position;

FIG. 19 is a rear elevation view of the design of FIG. 17 shown with the sheet dispensing device released from the utility belt, and the belt attachment flap in an opened position;

FIG. 20 is a front elevation view of an embodiment of the design of FIG. 17 with the sheet dispensing device shown in the open position to expose an elongated opening through which sheets may be dispensed;

FIG. 21 is a side elevation view of the design of FIG. 17 as viewed from the side adjacent to the right of the side shown in FIG. 17;

FIG. 22 is a side elevation view of the design of FIG. 17 as viewed from the side opposing the side shown in FIG. 21;

FIG. 23 is a bottom plan view of the design of FIG. 17 shown with the sheet dispensing device in a closed position, without the utility belt attached, and with the belt attachment flap in an opened position; and

FIG. 24 is a perspective view of the design of FIG. 17 with the sheet dispensing device shown in the open position.

### DETAILED DESCRIPTION OF THE EMBODIMENTS

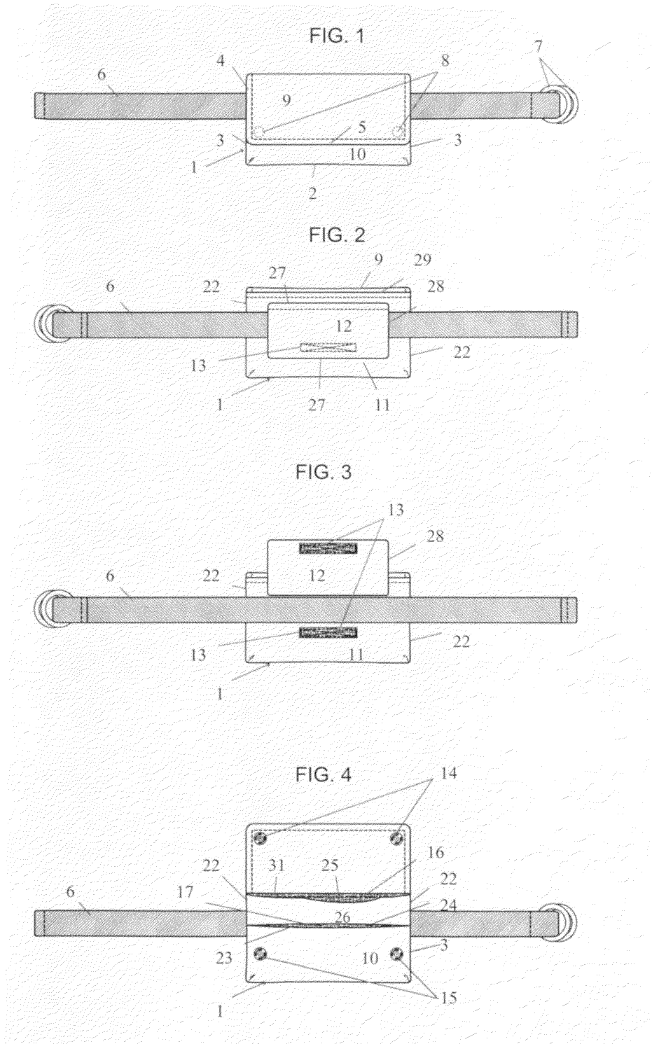

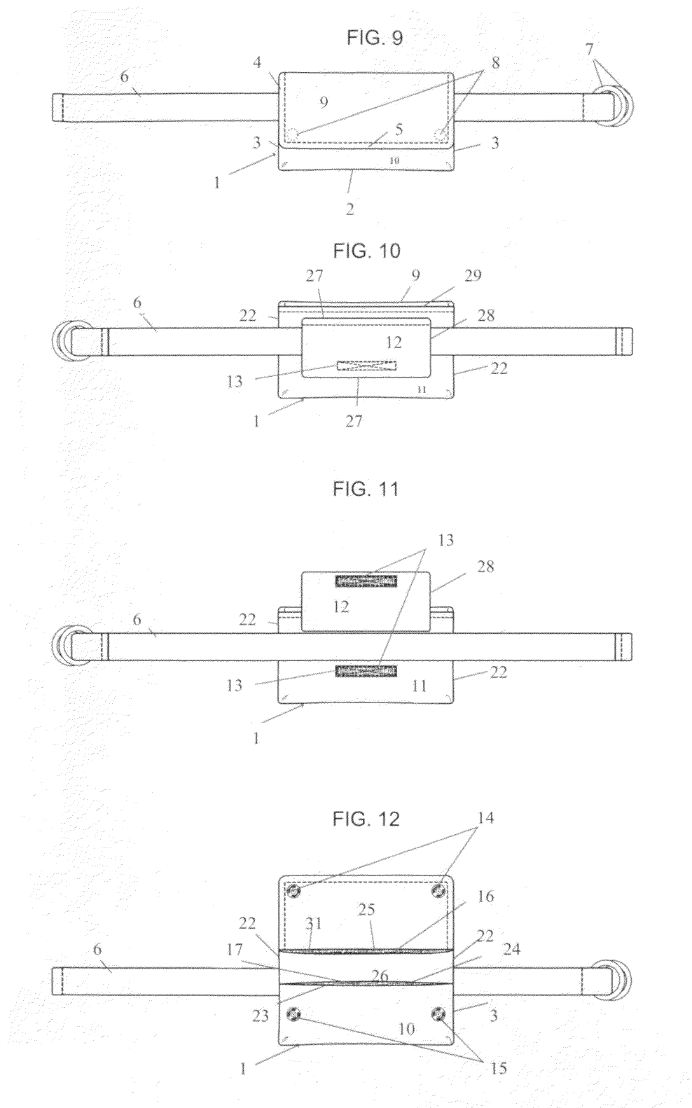

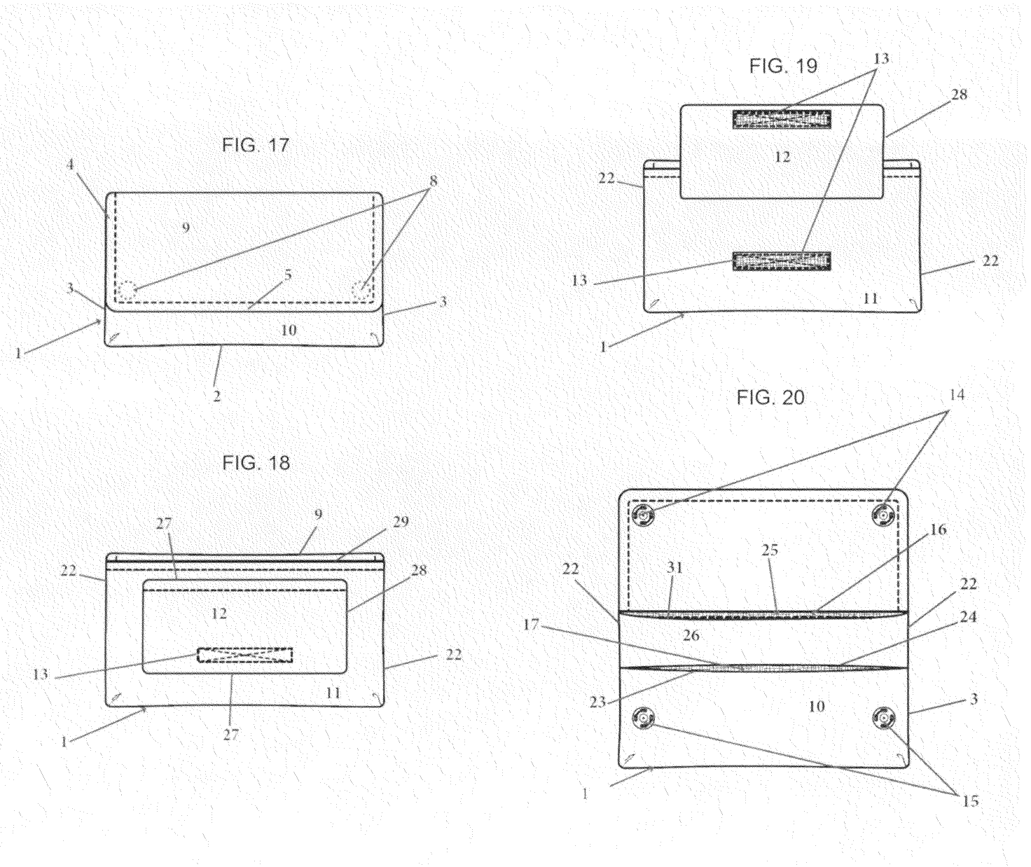

Referring to the illustrations shown in FIG. 1, FIG. 2, FIG. 3, FIG. 4, FIG. 7, FIG. 9, FIG. 10, FIG. 11, FIG. 12, FIG. 15, FIG. 17, FIG. 18, FIG. 19, FIG. 20, and FIG. 23 there are shown embodiments of the instant invention. In these embodiments, B.U.B. 1 comprises a front panel 10, which may further comprise either a separate or integral sheet dispensing panel 26, an opposed back panel 11, bottom panel 20, and side panels 18 formed in substantially rectangular sections of woven fabric.

In the various embodiments of the invention, front panel 10 may comprise slit 17 through which sheets placed in B.U.B. 1 may be dispensed. In the embodiment of the invention employing sheet dispensing panel 26 separate from front panel 10, slit 17 is formed by lower edge 24 of sheet dispensing panel 26 and upper edge 23 of front panel 10. Alternatively, in the embodiment of the invention employing sheet dispensing panel 26 which is integral or unitary with front panel 10, slit 17 is formed from a unitary panel by cutting slit 17 into front panel 10 to form lower edge 24 of sheet dispensing panel 26 and upper edge 23 of front panel 10.

The functionality of slit 17 may be improved by flattening, stiffening and/or otherwise reinforcing the surfaces which form slit 17, such as upper edge 23 and lower edge 24. Such flattening, stiffening and/or reinforcing may be achieved by ironing the edges of slit 17 with an iron into a flattened position, inserting stitches of thread around the edges of slit 17, and/or by other suitable flattening, stiffening and/or reinforcing means. A rigid material such as plastic or cardboard may also be inserted into the assembly of B.U.B. 1 around upper edge 23 and lower edge 24 which form slit 17 to increase the rigidity around slit 17.

In one embodiment of the invention, front panel 10, back panel 11, and bottom panel 20 may be made of one single rectangle piece of fabric, forming a U-shape when a packet of tissues is inserted, as shown in FIG. 4. Front panel 10, which may comprise separate or integral sheet dispensing panel 26, and back panel 11 may be joined to side panels 18 along their perimeters, creating an enclosure or chamber in which tissues or wipes may be placed. B.U.B. 1 may be constructed in whole or in part from woven brushed or un-brushed cotton, or other softer materials suitable for a small child to wear.

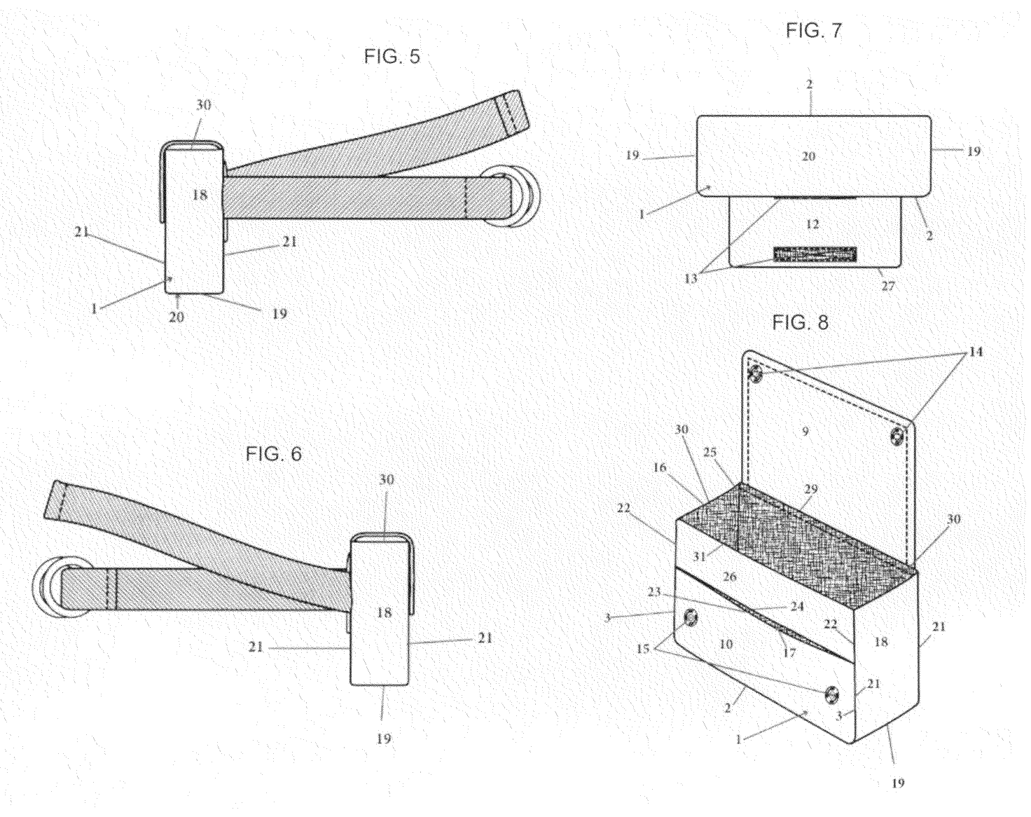

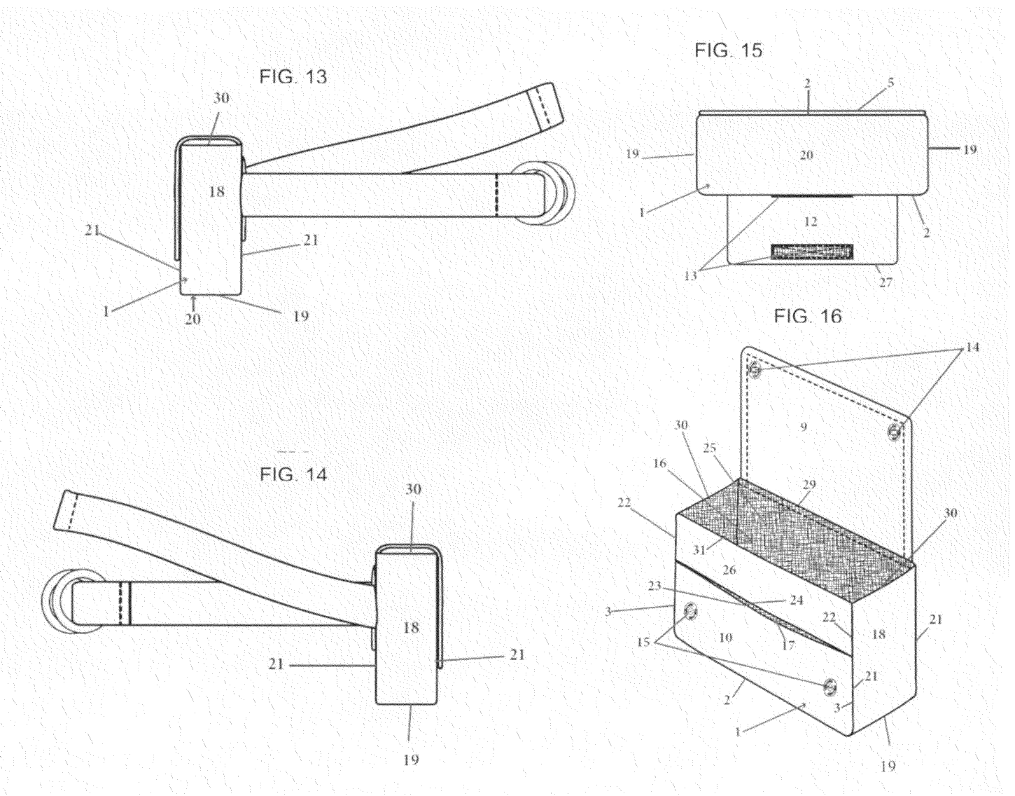

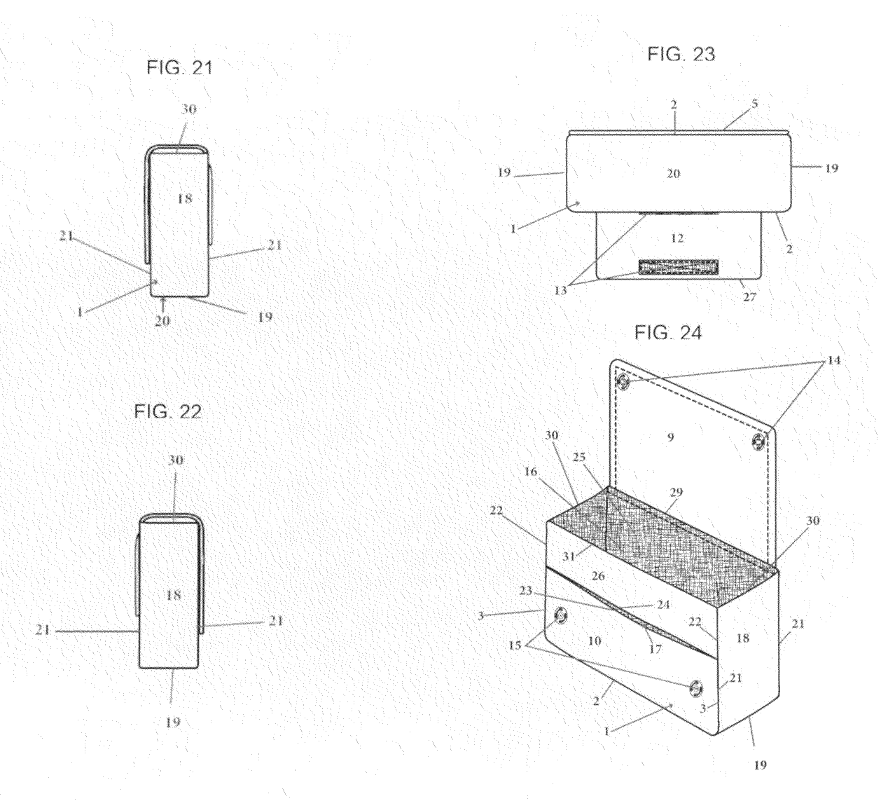

In one embodiment, B.U.B. 1 may be approximately 4.5 inches long along horizontal edges 2 (as shown in FIG. 1, FIG. 9 and FIG. 17), approximately 2.5 inches wide along vertical edges 21 (as shown in FIGS. 5 and 6, FIGS. 13 and 14, and FIGS. 21 and 22), and approximately 1 inch deep along side edges 19 (as shown in FIGS. 5, 6, and 7, FIGS. 13, 14, and 15, and FIGS. 21, 22 and 23). This sizing may accommodate a standard sized travel packet of tissues/or other desired articles.

B.U.B. 1 may optionally be fabricated from a rectangular piece of fabric, folded into 3 sections and creating front panel 10, back panel 11 and bottom panel 20. As shown in FIG. 4, FIG. 12 and FIG. 20, bottom edge 24 of sheet dispensing panel 26 may be lined up horizontally with top edge 23 of front panel 10. As shown in FIGS. 4, 5, 6 and 7, FIGS. 12, 13, 14, and 15, and FIGS. 20, 21, 22, and 23, vertical edges 22 of sheet dispensing panel 26 are then sewn to vertical edges 21 of side panels 18, ending approximately 1 inch down from the top of vertical edges 21. Starting approximately 1 inch down from the top of vertical edges 21, vertical edges 3 of front panel 10 may then be sewn to vertical edges 21 of side panels 18. As shown in FIGS. 5, 6 and 7, FIGS. 13, 14, and 15, and FIGS. 21, 22, and 23, horizontal edges 19 of bottom panel 20 are then sewn to horizontal edges 19 of side panel 18. As shown in FIG. 8, FIG. 16, and FIG. 24, vertical edges 21 of back panel 11 are then sewn to vertical edges 21 of side panel 18; and the remaining un-joined portion of B.U.B. 1 defines an opening 16.

As illustrated in FIG. 8, FIG. 16, and FIG. 24, opening 16 allows easy access to the interior chamber 25 of B.U.B. 1. In addition, as shown in FIGS. 4 and 8, FIGS. 12 and 16 and FIGS. 20 and 24, slit 17, formed by edges 23 and 24 of front panel 10 and sheet dispensing panel 26, respectively, may be employed to easily pull tissues out of B.U.B. 1, without having to remove the tissue packet from the pouch. Slit 17 may be approximately 4.5 inches long.

Also as shown in FIGS. 4 and 8, FIGS. 12 and 16 and FIGS. 20 and 24, both opening 16 and/or slit 17 may be covered by flap 9. Flap 9 may be attached as a separate panel to back panel 11 to form flap 9, or flap 9 may be part of a contiguous panel which comprises back panel 11. Flap 9 may be approximately 4.5 inches wide along horizontal edge 5 (as shown in FIG. 1, FIG. 9 and FIG. 17), and approximately 3 inches long along vertical edges 4 (also shown in FIG. 1, FIG. 9 and FIG. 17). Also as shown in FIGS. 1 and 8, FIGS. 9 and 16, and FIGS. 17 and 24, closure devices 8 may comprise hidden snaps. The centers of female snaps 14 may be placed approximately 0.5 inches in from edges 4 and 5. Male snaps 15 may then correspond with the placement of female snaps 14. Other methods of closure, such as, for example, Velcro®, zippers, belts and buckles, and/or magnets may also be used.

Turning now to FIGS. 2 and 3, FIGS. 10 and 11, and FIGS. 18 and 19, attached to back panel 11 is flap 12, located approximately 0.5 inches down from the top horizontal edge of back side 11, and horizontally centered in the approximate middle of back side 11. When closed with Velcro® closures 13, flap 12 serves as a channel for a belt 6 to go through, thus attaching pouch 1 to belt 6. Flap 12 may be approximately 3 inches wide along horizontal edge 27, and approximately 1.75 inches long along vertical edge 28. Velcro® closure 13 is ideally approximately 1.5 inches wide and approximately 0.25 inches high. Also, closure 13 may be located approximately ⅛ of an inch above bottom edge 27 and may be approximately centered horizontally on flap 12.

As shown in FIGS. 1, 2, 3, 4, 5, and 6, and FIGS. 9, 10, 11, 12, 13, and 14, is an adjustable, removable belt 6 of flexible material may be attached by channeling it through flap 12. Belt 6 may be made of a variety of materials such as elastic or woven cotton or synthetic material. Belt 6 may be narrower than the distance between the tops of Velcro® closures 13 and top edge 27 of flap 12, so it can be placed through that opening. Belt 6 may include a form of fastening, such as double ring fasteners 7 as shown in FIG. 1, and FIG. 9 placed on one end of belt for securing around the wearer's body. Other means of closures for belt 6 may be used also in this embodiment of the invention.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

What is claimed is:

1. A sheet dispensing device comprising:
a front surface, having a dispensing opening therein; and
a rear surface;
wherein said front surface and said rear surface form a compartment into which one or more sheets may be placed, and wherein said sheets may be dispensed through said dispensing opening.

2. The sheet dispensing device of claim 1, further comprising a flap which may be positioned to cover said dispensing opening.

3. The sheet dispensing device of claim 1, wherein said sheet dispensing device may be positioned on a belt.

4. The sheet dispensing device of claim 1, wherein said sheet dispensing device may be positioned on a belt together with one or more additional sheet dispensing devices or other devices each such device having similar or dissimilar functionality.

5. The sheet dispensing device of claim 4, wherein said other devices each such device having similar or dissimilar functionality may comprise a pocket for holding personal items.

6. The sheet dispensing device of claim 5, wherein said personal items may comprise pacifiers, medications, keys, money or toys.

7. The sheet dispensing device of claim 1, further comprising a belt attachment device, wherein said sheet dispensing device may be either removeably attached or affixed to a belt.

8. The sheet dispensing device of claim 7, wherein said belt attachment device comprises a belt attachment flap.

9. A sheet dispensing device comprising:
a front panel, having a dispensing opening therein;
a rear panel, wherein said front panel and said rear panel form a storage compartment which may house one or more sheets and may individually dispense said sheets through said dispensing opening; and
a cover flap wherein said cover flap, when in a closed position, substantially covers said dispensing opening.

10. The sheet dispensing device of claim 9, wherein said cover flap, when in a closed position, may be fastened to said front panel.

11. The sheet dispensing device of claim 9, further comprising a belt attachment device, wherein said sheet dispensing device may be either removeably attached or affixed to a belt.

12. The sheet dispensing device of claim 9, wherein said sheet dispensing device may be positioned on a belt together with one or more additional sheet dispensing or other devices, wherein each such device has similar or dissimilar functionality.

13. The sheet dispensing device of claim 11, wherein said belt attachment device comprises a belt attachment flap.

14. A method for assembling a sheet dispensing device comprising the steps of:
constructing a storage compartment which is suitable for housing one or more sheets to be dispensed;
forming a first opening in said storage compartment through which said one or more sheets may be dispensed; and
forming a flap which may be positioned to cover said first opening.

15. The method of claim 14, further comprising the step of:
forming a second opening in said storage compartment for receiving said one or more sheets into said compartment.

16. The method of claim 14, wherein said flap is affixed to said storage compartment.

17. The method of claim 14, wherein said storage compartment comprises a front panel and a rear panel.

18. The method of claim 14, wherein said first opening is on said front panel.

19. The method of claim 17, wherein at least a portion of said flap is affixed to said rear panel.

20. The method of claim 14, further comprising the step of flattening, stiffening and/or reinforcing said first opening.
